(19) United States
(12) Patent Application Publication
(10) Pub. No.: US 2010/0089516 A1
(43) Pub. Date: Apr. 15, 2010

(54) METHOD OF PRESERVATION OF THIN SECTION SPECIMEN

(76) Inventor: Tadafumi Kawamoto, Kanagawa (JP)

Correspondence Address: BUCHANAN, INGERSOLL & ROONEY PC, POST OFFICE BOX 1404, ALEXANDRIA, VA, 22313-1404, US

(21) Appl. No.: 12/527,677

(22) PCT Filed: Feb. 18, 2008
(86) PCT No.: PCT/JP2008/052672

§ 371 Date: Aug. 18, 2009

(30) Foreign Application Priority Data
Feb. 19, 2007 (JP) 2007-069449

(51) Int. Cl. G01N 1/28; A01N 3/00; A01N 1/00; G01N 1/36

(52) U.S. Cl. 156/57

(57) ABSTRACT

The present invention intends to mount and preserve a thin section prepared from a freeze-embedded sample using an adhesive plastic film as a support for the thin section, in a state of being attached to the adhesive plastic film, as a permanent specimen that can be observed on an optical microscope, after staining the thin section in a state of being attached to the adhesive plastic film. For this purpose, using an adhesive plastic film having a strong adhesion even at a lower temperature (e.g., −25° C.), a thin section that is kept in its shape is prepared. Subsequently, the thin section is stained while being attached to the adhesive plastic film. After that, the thin section is permeated with a water-soluble resin that can be polymerized upon irradiation with light or heating. The thin section is closely attached to a glass plate having the same resin coated thereon, and is then irradiated with light or heated, thereby causing polymerization of the water-soluble resin. Thus, the thin section can be mounted and preserved between the adhesive plastic film and the glass plate as a permanent specimen.

### TECHNICAL FIELD

The present invention belongs to a field of life science, and relates to a method of preservation of a thin section specimen in which a thin section, which has been prepared, when preparing the thin section from a freeze-embedded sample, using an adhesive plastic film as a support for the thin section, is stained in a state of being attached to the adhesive plastic film, and then thin section is mounted and preserved as a permanent specimen in the state of being attached to the adhesive plastic film.

### BACKGROUND ART

In a life science research, it is needed to prepare a thin section that has been kept in its shape from a sample which is fresh as much as possible, stain the thin section, and preserve the thin section as a permanent specimen. In general, a thin section from a fresh sample is prepared from a freeze-embedded sample without using any support for the thin section. However, there is a case that a thin section is prepared using an adhesive tape as a support for the thin section to prevent the thin section from being damaged during preparation thereof.

However, when a thin section adhesively supported on an adhesive tape is mounted and preserved by a conventional method, an organic solvent (e.g., xylene, alcohol, etc.) should be used, and due to the organic solvent, shrinkage of the thin section, softening of the adhesive tape, lowering of the adhesive force of the adhesive tape, or swelling of the adhesive tape is caused. As a result, the thin section may be deformed or damaged. Therefore, thin sections have been hardly mounted and preserved in a good state. In order to solve the aforementioned problems, the present inventor previously invented a method in which a thin section is prepared using an extremely thin adhesive plastic film. In this method, after staining the thin section, a water-soluble mounting agent (e.g., glycerin, etc.) is used for mounting the thin section between the adhesive plastic film and a glass plate (see Japanese Unexamined Patent Application Publication No. 2002-31586 published by the Japanese Patent Office). Although such a method now allows a thin section to be preserved without any breakage, because of mounting the thin section using the water-soluble mounting agent such as glycerin, etc., elution or diffusion of a stain from a stained tissue into the water-soluble mounting agent occurs during the preservation. As a result, there is a disadvantage in that the tissue image becomes indistinct during preservation of the thin section.

Japanese Unexamined Patent Application Publication No. 9-101242 published by the Japanese Patent Office discloses preparation of a thin section of a biological sample and processing of such a thin section by conventional procedures. In addition, Japanese Unexamined Patent Application Publication No. 2002-31586 published by the Japanese Patent Office discloses an adhesive plastic film suitable for preparation of a thin section.

When preparing a thin section that has been maintained in its shape (e.g., a frozen thin section), which is required in a life science research, adhesively supporting the thin section by a certain support is a rational way to prevent the thin section from being damaged. However, as described above, when a thin section prepared using an adhesive plastic film is mounted and preserved after staining, using a water-soluble mounting agent (e.g., glycerin), in a state of being attached to the adhesive plastic film, a stain disperses from the tissue into the water-soluble mounting agent and causes a problem of blurring the tissue image of the thin section. Therefore, the thin section has been hardly mounted and preserved in a good state as a permanent specimen.

### DISCLOSURE OF THE INVENTION

In order to solve the above-described problem, according to the present invention, a thin section prepared using an adhesive plastic film is stained in a state of being attached to the adhesive plastic film, thereafter, the thin section is permeated with a water-soluble resin, which is polymerized by light irradiation, UV irradiation, or heating, after that, the thin section is closely attached to a glass plate or a plastic plate applied with the same resin to sandwich the thin section between the adhesive plastic film and the glass plate, and subsequently, the water-soluble resin, which has been used for mounting the thin section, is polymerized by light irradiation, UV irradiation, or heating for a short time (e.g., within five minutes) to prevent a stain from dispersing into the mounting agent. Thereby, the thin section can be efficiently mounted and preserved as a permanent specimen with the shape thereof maintained and the tissue image in a distinct state.

According to the present invention, a thin section prepared using an adhesive plastic film as an adhesive support can be easily mounted and preserved as a permanent specimen in a state of being attached to the adhesive plastic film. For example, a thin section prepared using a transparent thin adhesive plastic film as an adhesive support is stained in a state of being attached to the adhesive plastic film. After that, according to the method of the present invention, the thin section can be preserved as a permanent specimen using a water-soluble resin such as one described for example in claims 5 and 6, in a state of being attached to the adhesive plastic film. Therefore, dehydration and clearization with an organic solvent (e.g., xylene, alcohol, etc.) used in the conventional method for mounting thin sections become unnecessary, so that the tissue can be prevented from being shrunk. In addition, the water-soluble resin used as a mounting agent is different from glycerin in that it polymerizes, so that a stain is prevented from being dispersed into the mounting agent. Therefore, the thin section can be provided as a permanent specimen in a state that the tissue image is distinct.

According to the method of the present invention, a thin section which has been mounted and preserved keeps the shape of the tissue therein exactly, and in addition, the thin section can be preserved as a permanent specimen in a state that a distinct tissue image is kept, and furthermore, the details of the thin section can be observed by an optical microscope. Therefore, the thin section prepared by the method of the present invention can be used in a wide variety of life scientific researches (e.g., histological researches, histochemical researches, enzyme histochemical researches, immunohistochemical researches, and genetic histochemical researches).

### BRIEF DESCRIPTION OF DRAWINGS

FIG. 1 is a cross sectional diagram illustrating a state that a thin section adhesively supported on an adhesive plastic film is closely attached to a glass plate on which a thin section mounting agent (water-soluble resin) has been applied.

FIG. 2 is a cross sectional diagram illustrating a state that the mounting agent is polymerized by heating in a state that a thin section has been mounted between the adhesive plastic film and the glass plate.

FIG. 3A is a cross sectional diagram illustrating a state that polymerization of the mounting agent is performed by light irradiation from above the top surface of a thin section in a state that the thin section has been mounted between the adhesive plastic film and the glass plate, and FIG. 3B is a cross sectional diagram illustrating a state that polymerization of the mounting agent is performed by light irradiation from under the bottom surface of the thin section.

FIG. 4 is a cross sectional diagram illustrating a state that after the adhesive plastic film has been removed from the section specimen mounted in FIG. 2 and FIG. 3, the thin section is then mounted under a cover glass using a mounting medium for a paraffin section or the resin which has been used for mounting the thin section.

### BEST MODE FOR CARRYING OUT THE INVENTION

Hereinafter, an embodiment of the present invention will be described with reference to the drawings.

The description will be made in order with respect to a method, in which a thin section prepared from a freeze-embedded sample by a cryomicrotome using an adhesive plastic film as a support of the thin section is stained in a state of being attached to the adhesive plastic film, and thereafter the thin section is mounted and preserved as a permanent specimen in the state of being attached to the adhesive plastic film.

i) First, a mounting agent 1 is prepared by mixing a polymerization initiator (e.g., trade name: DAROCUR 1173 or IRGACURE 500, manufactured by Chiba Specialty Chemicals Co., Ltd.) with a water-soluble resin (e.g., 2-hydroxypropyl methacrylate, 2-hydroxyethyl methacrylate, acryloyl morpholine, etc.). Here, the polymerization initiator polymerizes the water-soluble resin by light irradiation of natural light, fluorescent light, or the like, UV irradiation, or heating. The polymerization of the water-soluble resin may be accelerated by addition of a polymerization accelerator (e.g., dimethyl sulfoxide, etc.).

ii) Then, a thin section 3 is permeated with the mounting agent 1 prepared in (i).

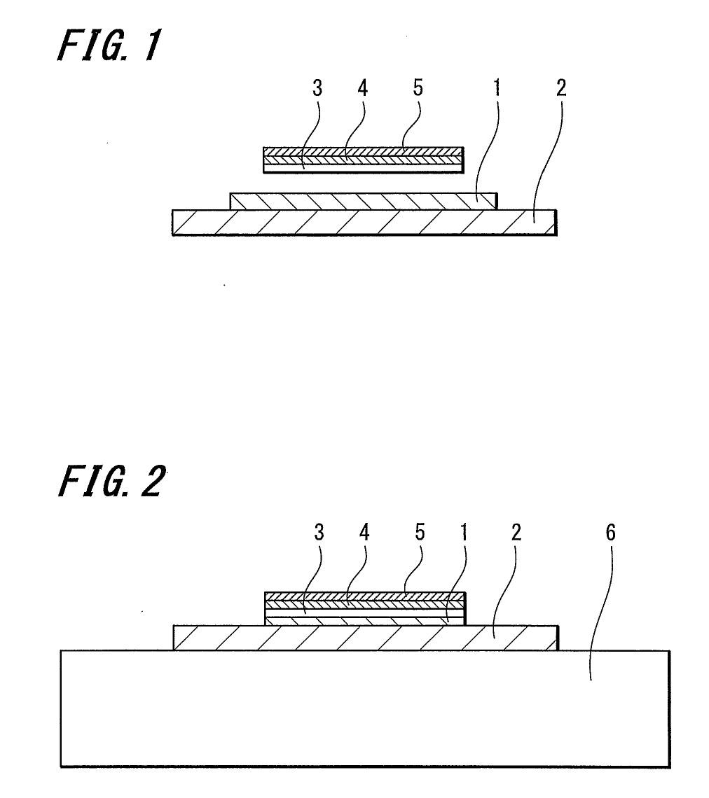

iii) As shown FIG. 1, the mounting agent 1 prepared in (i) is applied on the surface of a glass plate 2 (or plastic plate or a tape-shaped plastic), and the thin section 3 attached to an adhesive plastic film is then closely attached to the glass plate 2.

iv) Subsequently, an excessive portion of the mounting agent 1 is removed by pushing out using a sheet of filter paper or the like.

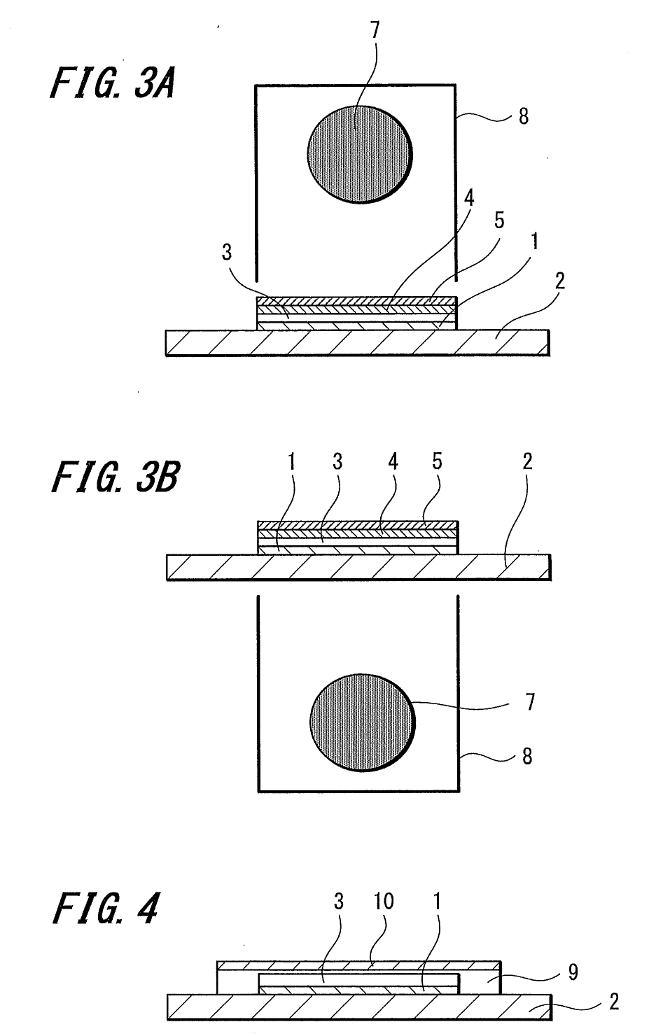

v) As shown in FIG. 2, the glass plate 2 closely attached to the thin section 3 by the operation in (iv) is placed on a heated plate (e.g., at 50 to 60° C.), and the mounting agent 1 is then polymerized. When the mounting agent 1 is polymerized by light irradiation, a light reflector 8 that also serves as a shield against leakage of light is placed around a lamp 7 so that irradiated light can be concentrated on the thin section as illustrated in FIG. 3A or FIG. 3B, and the mounting agent 1 is polymerized by powerful light from the lamp. As the lamp to be used, one that irradiates near UV rays with a little influence on the eyes and a strong photochemical action (UV-A, 310 to 400 nm in wavelength) is suitable. Alternatively, a fluorescent black light lamp may be used. The thin section 3 can be preserved as a permanent specimen between a plastic film 5 and the glass plate 2 by polymerizing of the mounting agent 1.

vi) Furthermore, when the thin section 3 is mounted and preserved using a cover glass 10 as shown in FIG. 4, the adhesive plastic film 5 is removed in an organic solvent from the specimen prepared by the operation in (i) to (v). Then, a mounting medium for a paraffin section 9 is dropped on the specimen. Subsequently, a cover glass 10 is closely attached thereon, thereby allowing the specimen to be preserved as a permanent specimen.

According to the above-described procedures, after a thin section prepared from an embedded (e.g., frozen and embedded) sample (e.g., nonfixed and undecalcified hard tissue, a brain, a whole body of an experimental animal, or a plant) and adhesively supported on an adhesive plastic film is stained in a state of being attached to the adhesive plastic film, the thin section is mounted and preserved as a permanent specimen in a state of being attached to the adhesive plastic film. Thereafter, the specimen can be observed in detail by an optical microscope.

In other words, an adhesive plastic film imparted with adhesiveness by processing with an adhesive is attached to a thin section side of a freeze-embedded sample, and a thin section is prepared by a cryomicrotome in a state that the adhesive plastic film has been attached. The thin section is stained in a state of being attached to the adhesive plastic film, and subsequently, the thin section is permeated with a water-soluble resin that can be polymerized upon irradiation with light or heating. The thin section in a state of being attached to the adhesive plastic film is closely attached to a glass plate or a plastic plate applied with the same resin and thereby the thin section is sandwiched between the adhesive plastic film and the glass plate or between the adhesive plastic film and the plastic plate. After that, the resin permeated in the thin section is polymerized by light irradiation or heating. Consequently, it becomes possible to mount and preserve the thin section as a permanent specimen between the adhesive plastic film and the glass plate or between the adhesive plastic film and the plastic plate.

Furthermore, an adhesive plastic film, prepared by applying an adhesive with a strong adhesive force even at a low temperature of −20° C. to a plastic film with a thickness of 2 to 30 μm while having non-adhesion areas at both ends thereof, is attached to a thin section side of a freeze-embedded biological tissue sample, and a thin section is prepared by a cryomicrotome in a state that the adhesive plastic film has been attached. The thin section is stained in a state of being attached to the adhesive plastic film, and subsequently, the thin section is permeated with a water-soluble resin that can be polymerized upon irradiation with light or heating. The thin section in a state of being attached to the adhesive plastic film is closely attached to a glass plate or a plastic plate applied with the same resin and thereby the thin section is sandwiched between the adhesive plastic film and the glass plate or between the adhesive plastic film and the plastic plate. After that, the resin permeated in the thin section is polymerized by light irradiation or heating. As a result, it becomes possible to mount and preserve the thin section as a permanent specimen between the adhesive plastic film and the glass plate or between the adhesive plastic film and the plastic plate.

Alternatively, a thin section, prepared by a cryomicrotome in a state that an adhesive plastic film prepared by applying an adhesive with a strong adhesive force even at a low temperature of −20° C. has been attached to a thin section side of a freeze-embedded sample, is stained in a state of being attached to the adhesive plastic film. Subsequently, the thin section is permeated with a water-soluble resin that can be polymerized upon irradiation with light or heating. The thin section in a state of being attached to the adhesive plastic film is closely attached to a glass plate or a plastic plate applied with the same resin and thereby the thin section is sandwiched between the adhesive plastic film and the glass plate or between the adhesive plastic film and the plastic plate. After that, the resin permeated in the thin section is polymerized by light irradiation or heating. Subsequently, the adhesive plastic film is removed. Then, a mounting medium for a paraffin section or the water-soluble resin used in mounting is dropped on the polymerized resin remained on the glass plate or the plastic plate and the thin section, which is then covered with a cover glass from above. Thereby, it becomes possible to mount and preserve the thin section as a permanent specimen between the cover glass and the glass plate or between the cover glass and the plastic plate.

Alternatively, an adhesive plastic film prepared by applying an adhesive to a plastic film with a thickness of 2 to 30 μm while having non-adhesion areas at both ends thereof is attached to a thin section side of a freeze-embedded sample, and a thin section is prepared by a cryomicrotome in a state that the adhesive plastic film has been attached. Then, the thin section is stained in a state of being attached to the adhesive plastic film. Subsequently, the thin section is permeated with a water-soluble resin that can be polymerized upon irradiation with light or heating. The thin section in a state of being attached to the adhesive plastic film is closely attached to a glass plate or a plastic plate applied with the same resin and thereby the thin section is sandwiched between the adhesive plastic film and the glass plate or between the adhesive plastic film and the plastic plate. Then, the resin permeated in the thin section is polymerized by light irradiation or heating. Subsequently, the adhesive plastic film is removed. A mounting medium for a paraffin section or the water-soluble resin used in mounting is dropped on the polymerized resin, which is then covered with a cover glass from above. Thereby, it becomes possible to mount and preserve the thin section as a permanent specimen between the cover glass and the glass plate or between the cover glass and the plastic plate.

Alternatively, the mounting agent used for mounting and preserving the thin section may be a water-soluble resin with a low viscosity, which can be easily mixed with water but cannot polymerize at room temperature. A polymerization initiator that polymerizes the water-soluble resin by light irradiation of natural light, fluorescent light, or the like, UV irradiation, or heating is added to the water-soluble resin, and after stirring, the thin section is permeated with the resin. The thin section in a state of being attached to the adhesive plastic film is closely attached to a glass plate applied with the same resin. Subsequently, the resin permeated in the thin section is polymerized by light irradiation, UV irradiation, or heating, thereby enabling mounting and preserving the thin section as a permanent specimen.

Alternatively, a mounting agent used for mounting and preserving the thin section may be a water-soluble resin with a low viscosity, which can be easily mixed with water but cannot polymerize at room temperature. A polymerization initiator that polymerizes the water-soluble resin by light irradiation or UV irradiation is added to the water-soluble resin. The amount of the polymerization initiator is an amount that does not polymerize the water-soluble resin over one year or more when the water-soluble resin is preserved in a cool, dark place or over one month or more when the water-soluble resin is preserved in a usual room. The polymerization initiator is added to the water-soluble resin and then stirred. After that, the thin section is permeated with such a resin. The thin section in a state of being attached to the adhesive plastic film is closely attached to a glass plate applied with the same resin. Then, the resin permeated in the thin section is polymerized by light irradiation, UV irradiation, or heating, thereby enabling mounting and preserving the thin section as a permanent specimen.

Alternatively, after the thin section, prepared by a cryomicrotome in a state that the adhesive plastic film is being attached to the thin section side of the freeze-embedded sample, has been stained while being attached to the adhesive plastic film, and subsequently the thin section has been permeated with a water-soluble resin that can be polymerized upon irradiation with light, and then the thin section in a state of being attached to the adhesive plastic film has been closely attached to a glass plate or a plastic plate applied with the same resin and sandwiched between the adhesive plastic film and the glass plate or between the adhesive plastic film and the plastic plate, when polymerizing the resin used for mounting the thin section, a device which is configured to irradiate the thin section with UV rays in a concentrated manner from directly above or directly below the thin section is used. The device is provided with a light reflector with an opening facing to the thin section sample, which also serves as a shield against leakage of light, around a lamp that efficiently irradiates near UV rays with a little influence on the eyes (UV-A, so-called UV 310 to 400 nm in wavelength) so that irradiated light can be concentrated on the thin section. Then, the resin permeated in the thin section is polymerized by UV irradiation within a short time (e.g., within five minutes), thereby enabling mounting and preserving the thin section as a permanent specimen.

Alternatively, after the thin section, prepared by a cryomicrotome in a state that the adhesive plastic film is being attached to the thin section side of the freeze-embedded sample, has been stained while being attached to the adhesive plastic film, and subsequently the thin section has been permeated with a water-soluble resin that can be polymerized upon irradiation with light, and then the thin section in a state of being attached to the adhesive plastic film has been closely attached to a glass plate or a plastic plate applied with the same resin and sandwiched between the adhesive plastic film and the glass plate or between the adhesive plastic film and the plastic plate, when polymerizing the resin used for mounting the thin section, a device which is configured to irradiate the thin section with UV rays in a concentrated manner from directly above or directly below the thin section is used. The device is provided with a light reflector with an opening facing to the thin section sample, which also serves as a shield against leakage of light, around a UV lamp with a little influence on the eyes, a strong photochemical action, and a peak wavelength of 340 to 370 nm (so-called black light) so that irradiation light can be concentrated on the thin section. Then, it becomes possible that the resin permeated in the thin section is polymerized by UV irradiation, thereby mounting and preserving the thin section as a permanent specimen.

### DESCRIPTION OF REFERENCE NUMERALS

1 Mounting agent for thin section (water-soluble resin)

2 Glass plate (or plastic plate)

3 Thin section

4 Adhesive

5 Plastic film

6 Heating plate

7 Ultraviolet (UV) lamp

8 Light reflector

9 Mounting medium for paraffin section

10 Cover glass

1. A method of preservation of a thin section specimen, comprising:
staining a thin section in a state of being attached to an adhesive plastic film, the adhesive plastic film having been imparted with adhesiveness by processing with an adhesive and attached to a thin section side of a freeze-embedded sample, and the thin section having been prepared by a cryomicrotome in a state that the adhesive plastic film had been attached thereto;
causing a water-soluble resin that can be polymerized by light irradiation or heating to permeate the thin section;
closely attaching the thin section in a state of being attached to the adhesive plastic film to a glass plate or a plastic plate applied with the same resin and sandwiching the thin section between the adhesive plastic film and the glass plate or between the adhesive plastic film and the plastic plate; and
polymerizing the resin permeated in the thin section by light irradiation or heating, thereby mounting and preserving the thin section as a permanent specimen between the adhesive plastic film and the glass plate or between the adhesive plastic film and the plastic plate.

2. A method of preservation of a thin section specimen, comprising:
staining a thin section in a state of being attached to an adhesive plastic film, the adhesive plastic film having been prepared by applying an adhesive with a strong adhesive force even at a low temperature of −20° C. to a plastic film with a thickness of 2 to 30 μm while having non-adhesion areas at both ends thereof and attached to a thin section side of a freeze-embedded biological tissue sample, and the thin section having been prepared by a cryomicrotome in a state of being attached to the adhesive plastic film;
causing a water-soluble resin that can be polymerized by light irradiation or heating to permeate the thin section;
closely attaching the thin section in a state of being attached to the adhesive plastic film to a glass plate or a plastic plate applied with the same water-soluble resin and sandwiching the thin section between the adhesive plastic film and the glass plate or between the adhesive plastic film and the plastic plate; and
polymerizing the resin permeated in the thin section by light irradiation or heating, thereby mounting and preserving the thin section as a permanent specimen between the adhesive plastic film and the glass plate or between the adhesive plastic film and the plastic plate.

3. A method of preservation of a thin section specimen, comprising:
staining a thin section in a state of being attached to an adhesive plastic film, the adhesive plastic film having been prepared by applying an adhesive with a strong adhesive force even at a low temperature of −20° C., and the thin section having been prepared by a cryomicrotome in a state that the adhesive plastic film had been attached to a thin section side of a freeze-embedded sample;
causing a water-soluble resin that can be polymerized by light irradiation or heating to permeate the thin section;
closely attaching the thin section in a state of being attached to the adhesive plastic film to a glass plate or a plastic plate applied with the same water-soluble resin and sandwiching the thin section between the adhesive plastic film and the glass plate or between the adhesive plastic film and the plastic plate;
polymerizing the resin permeated in the thin section by light irradiation or heating;
removing the adhesive plastic film;
dropping a mounting medium for a paraffin section or the water-soluble resin used in mounting on the polymerized resin remained on the glass plate or the plastic plate and the thin section; and
covering the dropped mounting medium for a paraffin section or water-soluble resin with a cover glass from above, thereby mounting and preserving the thin section as a permanent specimen between the cover glass and the glass plate or between the cover glass and the plastic plate.

4. A method of preservation of a thin section specimen, comprising:
staining a thin section in a state of being attached to an adhesive plastic film, the adhesive plastic film having been prepared by applying an adhesive with a strong adhesive force even at a low temperature of −20° C. to a plastic film with a thickness of 2 to 30 μm while having non-adhesion areas at both ends thereof and attached to a thin section side of a freeze-embedded sample, and the thin section having been prepared by a cryomicrotome in a state that the adhesive plastic film had been attached;
causing a water-soluble resin that can be polymerized upon irradiation with light or heating to permeate the thin section;
closely attaching the thin section in a state of being attached to the adhesive plastic film to a glass plate or a plastic plate applied with the same water-soluble resin and sandwiching the thin section between the adhesive plastic film and the glass plate or between the adhesive plastic film and the plastic plate;
polymerizing the resin permeated in the thin section by light irradiation or heating;
removing the adhesive plastic film;
dropping a mounting medium for a paraffin section or the water-soluble resin used in mounting on the polymerized resin; and
covering the dropped mounting medium for a paraffin section or water-soluble resin with a cover glass from above, thereby mounting and preserving the thin section as a permanent specimen between the cover glass and the glass plate or between the cover glass and the plastic plate.

5. The method of preservation of a thin section specimen according to claim 1, wherein a mounting medium used for mounting and preserving the thin section is a water-soluble resin with a low viscosity, which can be easily mixed with water but cannot polymerize at room temperature, a polymerization initiator that polymerizes the water-soluble resin by light irradiation of natural light, fluorescent light, or the like, UV irradiation, or heating is added to the water-soluble resin and after stirring, the thin section is permeated with the resin, and the thin section in a state of being attached to the adhesive plastic film is closely attached to a glass plate applied with the same resin, and thereafter the resin permeated in the thin section is polymerized by light irradiation, UV irradiation, or heating, thereby mounting and preserving the thin section as a permanent specimen.

6. The method of preservation of a thin section specimen according to claim 1, wherein a mounting medium used for mounting and preserving the thin section is a water-soluble resin with a low viscosity, which can be easily mixed with water but cannot polymerize at room temperature, a polymerization initiator that polymerizes the water-soluble resin by light irradiation or UV irradiation is added to the water-soluble resin, the amount of the polymerization initiator being an amount that does not polymerize the water-soluble resin over six months or more when the water-soluble resin is preserved in a cool dark place or over one month or more when the water-soluble resin is preserved in a usual room, and after the polymerization initiator is added to the water-soluble resin and then stirred, the thin section is permeated with such a resin, and the thin section in a state of being attached to the adhesive plastic film is closely attached to a glass plate applied with the same resin, and thereafter the resin permeated in the thin section is polymerized by light irradiation, UV irradiation, or heating, thereby mounting and preserving the thin section as a permanent specimen.

7. The method of preservation of a thin section specimen according to claim 1, wherein after the thin section, prepared by a cryomicrotome in a state that the adhesive plastic film is being attached to the thin section side of the freeze-embedded sample, has been stained in a state of being attached to the adhesive plastic film, and subsequently the thin section has been permeated with a water-soluble resin that can be polymerized upon irradiation with light, and then the thin section in a state of being attached to the adhesive plastic film has been closely attached to a glass plate or a plastic plate applied with the same resin and thereby the thin section has been sandwiched between the adhesive plastic film and the glass plate or between the adhesive plastic film and the plastic plate, when polymerizing the resin used for mounting the thin section, a device is used to allow the resin permeated in the thin section to be polymerized by UV irradiation, thereby mounting and preserving the thin section as a permanent specimen, the device being provided with a light reflector having an opening facing to the thin section sample and serving as a shield against leakage of light, around a lamp that efficiently irradiates near UV rays with a little influence on the eyes, so as to concentrate light on the thin section and configured to irradiate the thin section with UV rays in a concentrated manner from directly above or directly below the thin section.

8. The method of preservation of a thin section specimen according to claim 1, wherein after the thin section, prepared by a cryomicrotome in a state that the adhesive plastic film is being attached to the thin section side of the freeze-embedded sample, has been stained in a state of being attached to the adhesive plastic film, and subsequently the thin section has been permeated with a water-soluble resin that can be polymerized upon irradiation with light, and then the thin section in a state of being attached to the adhesive plastic film has been closely attached to a glass plate or a plastic plate applied with the same resin and thereby the thin section has been sandwiched between the adhesive plastic film and the glass plate or between the adhesive plastic film and the plastic plate, when polymerizing the resin used for mounting the thin section, a device is used to allow the resin permeated in the thin section to be polymerized by UV irradiation, thereby mounting and preserving the thin section as a permanent specimen, the device being provided with a light reflector having an opening facing to the thin section sample and serving as a shield against leakage of light, around an UV lamp with a little influence on the eyes, a strong photochemical action, and a peak wavelength of 340 to 400 nm, and the device irradiating the thin section with UV rays from directly above or directly below the thin section.

9. The method of preservation of a thin section specimen according to claim 2, wherein a mounting medium used for mounting and preserving the thin section is a water-soluble resin with a low viscosity, which can be easily mixed with water but cannot polymerize at room temperature, a polymerization initiator that polymerizes the water-soluble resin by light irradiation of natural light, fluorescent light, or the like, UV irradiation, or heating is added to the water-soluble resin and after stirring, the thin section is permeated with the resin, and the thin section in a state of being attached to the adhesive plastic film is closely attached to a glass plate applied with the same resin, and thereafter the resin permeated in the thin section is polymerized by light irradiation, UV irradiation, or heating, thereby mounting and preserving the thin section as a permanent specimen.

10. The method of preservation of a thin section specimen according to claim 3, wherein a mounting medium used for mounting and preserving the thin section is a water-soluble resin with a low viscosity, which can be easily mixed with water but cannot polymerize at room temperature, a polymerization initiator that polymerizes the water-soluble resin by light irradiation of natural light, fluorescent light, or the like, UV irradiation, or heating is added to the water-soluble resin and after stirring, the thin section is permeated with the resin, and the thin section in a state of being attached to the adhesive plastic film is closely attached to a glass plate applied with the same resin, and thereafter the resin permeated in the thin section is polymerized by light irradiation, UV irradiation, or heating, thereby mounting and preserving the thin section as a permanent specimen.

11. The method of preservation of a thin section specimen according to claim 4, wherein a mounting medium used for mounting and preserving the thin section is a water-soluble resin with a low viscosity, which can be easily mixed with water but cannot polymerize at room temperature, a polymerization initiator that polymerizes the water-soluble resin by light irradiation of natural light, fluorescent light, or the like, UV irradiation, or heating is added to the water-soluble resin and after stirring, the thin section is permeated with the resin, and the thin section in a state of being attached to the adhesive plastic film is closely attached to a glass plate applied with the same resin, and thereafter the resin permeated in the thin section is polymerized by light irradiation, UV irradiation, or heating, thereby mounting and preserving the thin section as a permanent specimen.

12. The method of preservation of a thin section specimen according to claim 2, wherein a mounting medium used for mounting and preserving the thin section is a water-soluble resin with a low viscosity, which can be easily mixed with water but cannot polymerize at room temperature, a polymerization initiator that polymerizes the water-soluble resin by light irradiation or UV irradiation is added to the water-soluble resin, the amount of the polymerization initiator being an amount that does not polymerize the water-soluble resin over six months or more when the water-soluble resin is preserved in a cool dark place or over one month or more when the water-soluble resin is preserved in a usual room, and after the polymerization initiator is added to the water-soluble resin and then stirred, the thin section is permeated with such a resin, and the thin section in a state of being attached to the adhesive plastic film is closely attached to a glass plate applied with the same resin, and thereafter the resin permeated in the thin section is polymerized by light irradiation, UV irradiation, or heating, thereby mounting and preserving the thin section as a permanent specimen.

13. The method of preservation of a thin section specimen according to claim 3, wherein a mounting medium used for mounting and preserving the thin section is a water-soluble resin with a low viscosity, which can be easily mixed with water but cannot polymerize at room temperature, a polymerization initiator that polymerizes the water-soluble resin by light irradiation or UV irradiation is added to the water-soluble resin, the amount of the polymerization initiator being an amount that does not polymerize the water-soluble resin over six months or more when the water-soluble resin is preserved in a cool dark place or over one month or more when the water-soluble resin is preserved in a usual room, and after the polymerization initiator is added to the water-soluble resin and then stirred, the thin section is permeated with such a resin, and the thin section in a state of being attached to the adhesive plastic film is closely attached to a glass plate applied with the same resin, and thereafter the resin permeated in the thin section is polymerized by light irradiation, UV irradiation, or heating, thereby mounting and preserving the thin section as a permanent specimen.

14. The method of preservation of a thin section specimen according to claim 4, wherein a mounting medium used for mounting and preserving the thin section is a water-soluble resin with a low viscosity, which can be easily mixed with water but cannot polymerize at room temperature, a polymerization initiator that polymerizes the water-soluble resin by light irradiation or UV irradiation is added to the water-soluble resin, the amount of the polymerization initiator being an amount that does not polymerize the water-soluble resin over six months or more when the water-soluble resin is preserved in a cool dark place or over one month or more when the water-soluble resin is preserved in a usual room, and after the polymerization initiator is added to the water-soluble resin and then stirred, the thin section is permeated with such a resin, and the thin section in a state of being attached to the adhesive plastic film is closely attached to a glass plate applied with the same resin, and thereafter the resin permeated in the thin section is polymerized by light irradiation, UV irradiation, or heating, thereby mounting and preserving the thin section as a permanent specimen.

15. The method of preservation of a thin section specimen according to claim 2, wherein after the thin section, prepared by a cryomicrotome in a state that the adhesive plastic film is being attached to the thin section side of the freeze-embedded sample, has been stained in a state of being attached to the adhesive plastic film, and subsequently the thin section has been permeated with a water-soluble resin that can be polymerized upon irradiation with light, and then the thin section in a state of being attached to the adhesive plastic film has been closely attached to a glass plate or a plastic plate applied with the same resin and thereby the thin section has been sandwiched between the adhesive plastic film and the glass plate or between the adhesive plastic film and the plastic plate, when polymerizing the resin used for mounting the thin section, a device is used to allow the resin permeated in the thin section to be polymerized by UV irradiation, thereby mounting and preserving the thin section as a permanent specimen, the device being provided with a light reflector having an opening facing to the thin section sample and serving as a shield against leakage of light, around a lamp that efficiently irradiates near UV rays with a little influence on the eyes, so as to concentrate light on the thin section and configured to irradiate the thin section with UV rays in a concentrated manner from directly above or directly below the thin section.

16. The method of preservation of a thin section specimen according to claim 3, wherein after the thin section, prepared by a cryomicrotome in a state that the adhesive plastic film is being attached to the thin section side of the freeze-embedded sample, has been stained in a state of being attached to the adhesive plastic film, and subsequently the thin section has been permeated with a water-soluble resin that can be polymerized upon irradiation with light, and then the thin section in a state of being attached to the adhesive plastic film has been closely attached to a glass plate or a plastic plate applied with the same resin and thereby the thin section has been sandwiched between the adhesive plastic film and the glass plate or between the adhesive plastic film and the plastic plate, when polymerizing the resin used for mounting the thin section, a device is used to allow the resin permeated in the thin section to be polymerized by UV irradiation, thereby mounting and preserving the thin section as a permanent specimen, the device being provided with a light reflector having an opening facing to the thin section sample and serving as a shield against leakage of light, around a lamp that efficiently irradiates near UV rays with a little influence on the eyes, so as to concentrate light on the thin section and configured to irradiate the thin section with UV rays in a concentrated manner from directly above or directly below the thin section.

17. The method of preservation of a thin section specimen according to claim 4, wherein after the thin section, prepared by a cryomicrotome in a state that the adhesive plastic film is being attached to the thin section side of the freeze-embedded sample, has been stained in a state of being attached to the adhesive plastic film, and subsequently the thin section has been permeated with a water-soluble resin that can be polymerized upon irradiation with light, and then the thin section in a state of being attached to the adhesive plastic film has been closely attached to a glass plate or a plastic plate applied with the same resin and thereby the thin section has been sandwiched between the adhesive plastic film and the glass plate or between the adhesive plastic film and the plastic plate, when polymerizing the resin used for mounting the thin section, a device is used to allow the resin permeated in the thin section to be polymerized by UV irradiation, thereby mounting and preserving the thin section as a permanent specimen, the device being provided with a light reflector having an opening facing to the thin section sample and serving as a shield against leakage of light, around a lamp that efficiently irradiates near UV rays with a little influence on the eyes, so as to concentrate light on the thin section and configured to irradiate the thin section with UV rays in a concentrated manner from directly above or directly below the thin section.

18. The method of preservation of a thin section specimen according to claim 2, wherein after the thin section, prepared by a cryomicrotome in a state that the adhesive plastic film is being attached to the thin section side of the freeze-embedded sample, has been stained in a state of being attached to the adhesive plastic film, and subsequently the thin section has been permeated with a water-soluble resin that can be polymerized upon irradiation with light, and then the thin section in a state of being attached to the adhesive plastic film has been closely attached to a glass plate or a plastic plate applied with the same resin and thereby the thin section has been sandwiched between the adhesive plastic film and the glass plate or between the adhesive plastic film and the plastic plate, when polymerizing the resin used for mounting the thin section, a device is used to allow the resin permeated in the thin section to be polymerized by UV irradiation, thereby mounting and preserving the thin section as a permanent specimen, the device being provided with a light reflector having an opening facing to the thin section sample and serving as a shield against leakage of light, around an UV lamp with a little influence on the eyes, a strong photochemical action, and a peak wavelength of 340 to 400 nm, and the device irradiating the thin section with UV rays from directly above or directly below the thin section.

19. The method of preservation of a thin section specimen according to claim 3, wherein after the thin section, prepared by a cryomicrotome in a state that the adhesive plastic film is being attached to the thin section side of the freeze-embedded sample, has been stained in a state of being attached to the adhesive plastic film, and subsequently the thin section has been permeated with a water-soluble resin that can be polymerized upon irradiation with light, and then the thin section in a state of being attached to the adhesive plastic film has been closely attached to a glass plate or a plastic plate applied with the same resin and thereby the thin section has been sandwiched between the adhesive plastic film and the glass plate or between the adhesive plastic film and the plastic plate, when polymerizing the resin used for mounting the thin section, a device is used to allow the resin permeated in the thin section to be polymerized by UV irradiation, thereby mounting and preserving the thin section as a permanent specimen, the device being provided with a light reflector having an opening facing to the thin section sample and serving as a shield against leakage of light, around an UV lamp with a little influence on the eyes, a strong photochemical action, and a peak wavelength of 340 to 400 nm, and the device irradiating the thin section with UV rays from directly above or directly below the thin section.

20. The method of preservation of a thin section specimen according to claim 4, wherein after the thin section, prepared by a cryomicrotome in a state that the adhesive plastic film is being attached to the thin section side of the freeze-embedded sample, has been stained in a state of being attached to the adhesive plastic film, and subsequently the thin section has been permeated with a water-soluble resin that can be polymerized upon irradiation with light, and then the thin section in a state of being attached to the adhesive plastic film has been closely attached to a glass plate or a plastic plate applied with the same resin and thereby the thin section has been sandwiched between the adhesive plastic film and the glass plate or between the adhesive plastic film and the plastic plate, when polymerizing the resin used for mounting the thin section, a device is used to allow the resin permeated in the thin section to be polymerized by UV irradiation, thereby mounting and preserving the thin section as a permanent specimen, the device being provided with a light reflector having an opening facing to the thin section sample and serving as a shield against leakage of light, around an UV lamp with a little influence on the eyes, a strong photochemical action, and a peak wavelength of 340 to 400 nm, and the device irradiating the thin section with UV rays from directly above or directly below the thin section.
